(19) United States
(12) Patent Application Publication
(10) Pub. No.: US 2020/0179086 A1
(43) Pub. Date: Jun. 11, 2020

(54) NARROWED IMPLANT POST

(71) Applicant: DENTATUS USA LTD., New York, NY (US)

(72) Inventor: Bernard WEISSMAN, New York, NY (US)

(21) Appl. No.: 16/631,476

(22) PCT Filed: Jul. 23, 2018
(86) PCT No.: PCT/US2018/043292

§ 371 Date: Jan. 16, 2020

Related U.S. Application Data
(60) Provisional application No. 62/535,461, filed on Jul. 21, 2017.

(51) Int. Cl. A61C 8/00

(52) U.S. Cl. CPC A61C 8/0037; A61C 8/0048

(57) ABSTRACT

A dental implant includes a crown socket for supporting a prosthetic tooth, the crown socket comprising a first longitudinal axis for supporting the prosthetic tooth in an anatomically correct shape; an abutment; and an implant post having a second longitudinal axis coinciding with a third longitudinal axis of an osteotomy; the first longitudinal axis and the second longitudinal axis are not coincident.

### BACKGROUND OF THE INVENTION

### 1. Field of the Invention

The present invention relates to improvements in prosthetic implant posts for implant dentistry.

### 2. Discussion of the Related Art

In implant dentistry, a replacement tooth is permanently secured to a patient's maxilla, i.e., upper jaw, or the mandible, i.e., jaw bone, by taking advantage of the body's willingness to osseointegrate certain materials. The replacement tooth comprises an implant post, typically made of titanium, which is secured into an opening, i.e., osteotomy, which has been previously prepared by a dentist or dental surgeon, i.e., dentist, in the patient, i.e., implant site. In due course, the natural bone adheres to the implant post. After a certain period, a physiologically correct crown is secured to the crown socket of the implant to provide a prosthetic tooth that can be used like a natural tooth.

A satisfactory implantation meets two conditions: (1) an implant post is secured to solid bone and (2) the crown of the implant (or the crown of a bridge supported by one or more implant posts) is properly aligned relative to the crown of the adjacent teeth to meet the patient's functional and aesthetic needs.

FIG. 1a is a schematic plan view of an idealized jaw and FIG. 1b is a partial rear view of the idealized jaw of FIG. 1a. FIG. 1c is a schematic plan view of the implant spaces for the idealized jaw of FIG. 1a. FIG. 1d is a partial rear view of the idealized jaw of FIG. 1a. Therein, a mandibular jaw 2 includes teeth 3 that are spaced-apart at a preferred distance from each other such that the teeth develops normally and meet the patient's functional and aesthetic needs. When a patient is in need of an implant, one or more suitable implant posts can be placed into respective implant spaces 4 that do not interfere with each other.

FIG. 2a is a schematic plan view of a non-idealized jaw. FIG. 2c is a schematic plan view of the implant spaces for the non-idealized jaw of FIG. 2a. FIG. 2d is a detail view of one or more interference regions. FIG. 2e is a partial rear view of the non-idealized jaw of FIG. 2c indicating the one or more interference regions of 2c. Therein, a mandibular jaw 2a includes teeth 3a that are spaced-apart at a non-idealized distance from each other. Although, the teeth are not ideal, they have developed substantially normally and substantially meet the patient's functional and aesthetic needs. However, when a patient is in need of an implant, one or more suitable implant posts will need to be placed into respective implant spaces 4a that may interfere with each other in interference regions 5a.

Although, a mandibular jaw is illustrated in FIGS. 1a, 1b, 1c, 2a, 2b, 2c, 2d, and 2e the same situation arises in a maxillary jaw.

Thus, what is needed is an implant post that is narrowed and permits implantation in the jaw of a patient when the teeth are spaced such that one or more full body implants may interfere with each other.

The following patents and/or applications hereby incorporated by reference in their entirety for all purposes: U.S. Pat. Nos. 5,785,525 and 6,685,473.

### SUMMARY OF THE INVENTION

These and other needs are met by the present invention.

A dental implant includes
a crown socket for supporting a prosthetic tooth in an anatomically correct shape;
an abutment; and
an implant post having a first longitudinal axis coinciding with a second longitudinal axis of an osteotomy;
wherein the implant post does not comprise a circular cross-section in the second longitudinal axis.

Further, the implant post includes a rectangular cross-section perpendicular to the, the rectangular cross-section having a first side longer than a second side.

The implant post also includes a first shank portion and a second shank portion, the second shank portion being rotated relative to the first shank portion.

The first shank portion is joined to the second portion by a twist portion.

A dental implant includes
a crown socket for supporting a prosthetic tooth, the crown socket comprising a first longitudinal axis for supporting the prosthetic tooth in an anatomically correct shape;
an abutment; and
an implant post having a second longitudinal axis coinciding with a third longitudinal axis of an osteotomy;
wherein the first longitudinal axis and the second longitudinal axis are not coincident.

The crown socket is bent at a juncture relative to the implant post.

The implant post comprises a plurality of sections. Each section is joined by a transition section to another sections.

The transition section includes a V-notch.

### BRIEF DESCRIPTION OF THE DRAWINGS

FIG. 1a is a schematic plan view of an idealized jaw.

FIG. 1b is a partial rear view of the idealized jaw of FIG. 1a.

FIG. 1c is a schematic plan view of the implant spaces for the idealized jaw of FIG. 1a.

FIG. 1d is a partial rear view of the idealized jaw of FIG. 1c indicating the implant spaces.

FIG. 2a is a schematic plan view of a non-idealized jaw.

FIG. 2b is a partial rear view of the non-idealized jaw of FIG. 2a.

FIG. 2c is a schematic plan view of the implant spaces for the non-idealized jaw of FIG. 2a.

FIG. 2d is a detail view of one or more interference regions.

FIG. 2e is a partial rear view of the non-idealized jaw of FIG. 2c indicating the one or more interference regions of 2c.

FIG. 3a is a front view of an implant in accordance with one or more embodiments of the present invention.

FIG. 3b is a side view of the implant of FIG. 3a.

FIGS. 3c-3h are cross-sectional views of an implant post of FIGS. 3a and 3b taken at line I-I.

FIGS. 3i and 3i are cross-sectional views of an implant post of FIGS. 3a and 3b taken at line II-II.

FIGS. 3k and 31 are isometric views of an implant in accordance with one or more embodiments of the present invention.

FIG. 3m is a schematic of implant of FIGS. 3a and 3b illustrating a bend in the implant.

FIG. 4a is a front view of an implant in accordance with one or more embodiments of the present invention.

FIG. 4b is a side view of the implant of FIG. 4a.

FIGS. 4c-4e are cross-sectional views of an implant post of FIGS. 4a and 4b taken at line

FIG. 4f is a schematic views of the planes of implant of FIGS. 4a and 4b.

FIG. 4g is an isometric view of an implant in accordance with one or more embodiments of the present invention.

FIG. 4h is a schematic of implant of FIGS. 4a and 4b illustrating a bend in the implant.

FIG. 5a is a front view of an implant in accordance with one or more embodiments of the present invention.

FIG. 5b is a side view of the implant of FIG. 5a.

FIG. 5c is a schematic of implant of FIGS. 5a and 5b illustrating one or more bends in the implant.

FIG. 6a is a side view of an implant in accordance with one or more embodiments of the present invention.

FIG. 6b is a front view of the implant of FIG. 6a.

FIG. 6c is a schematic of implant of FIGS. 6a and 6b illustrating one or more bends in the implant.

FIGS. 7a and 7b are schematic views of an osteotomy in accordance with one or more embodiments of the present invention.

FIG. 8 is a schematic of a method of performing an osteotomy in accordance with one or more embodiments of the present invention.

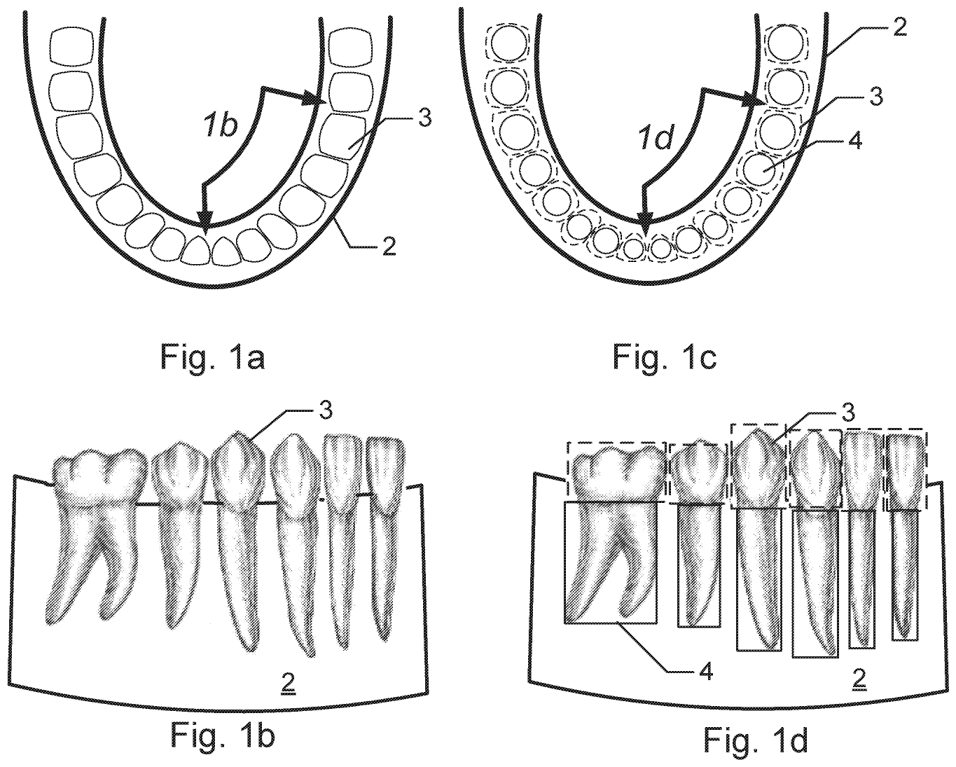

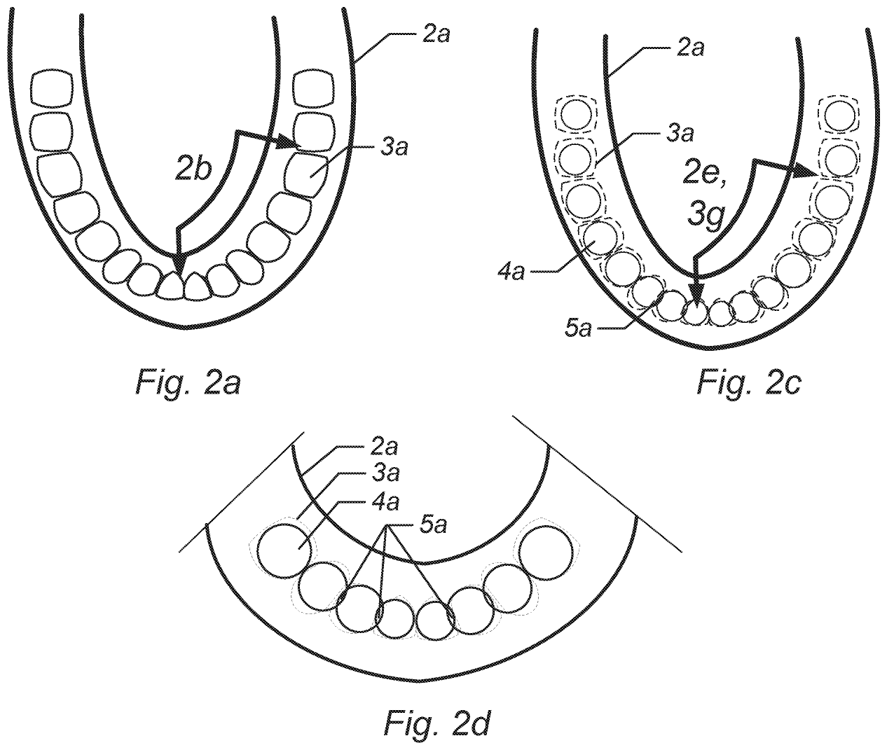

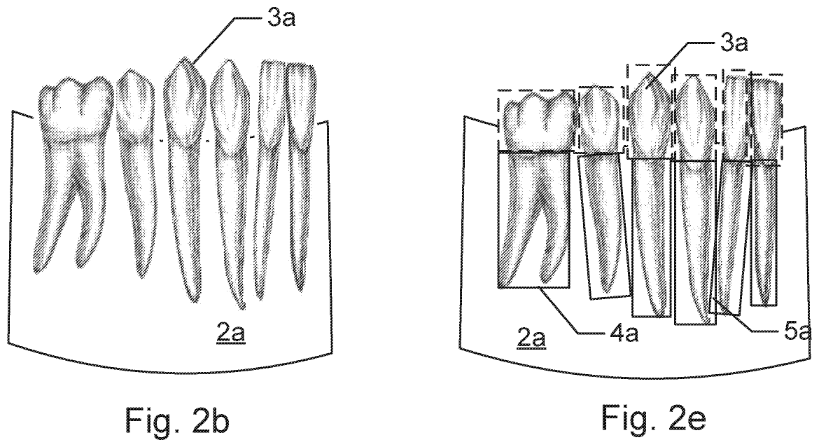

### DETAILED DESCRIPTION OF THE INVENTION

Reference will now be made in detail to several views of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, left, right, up, down, over, above, below, beneath, rear, and front may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

In accordance with one or more embodiments of the present invention, the implant posts disclosed herein comprise a threaded portion, even when not shown, on an exterior surface of the implant post.

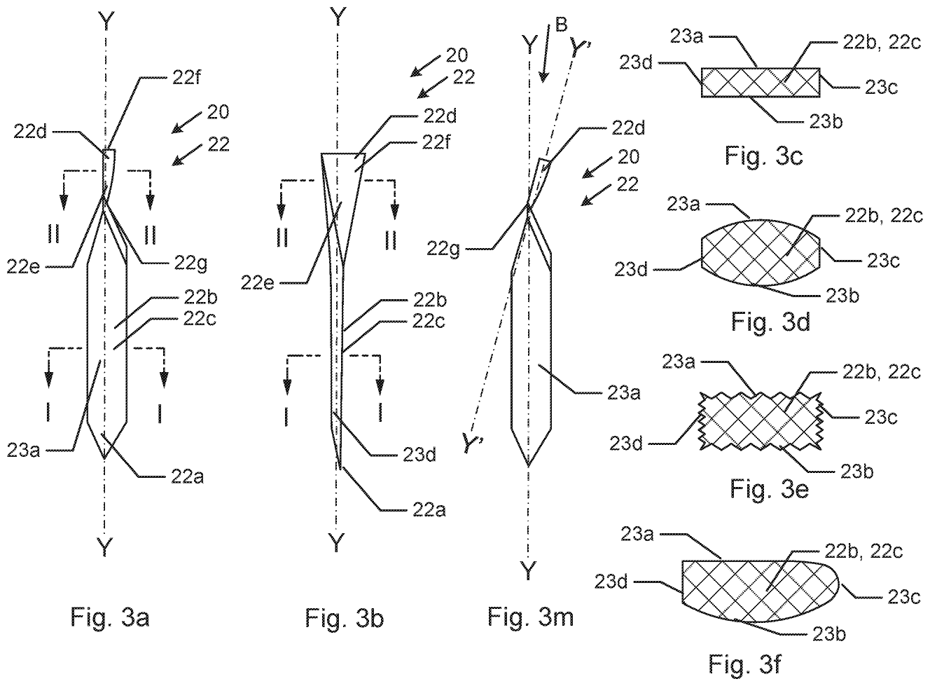

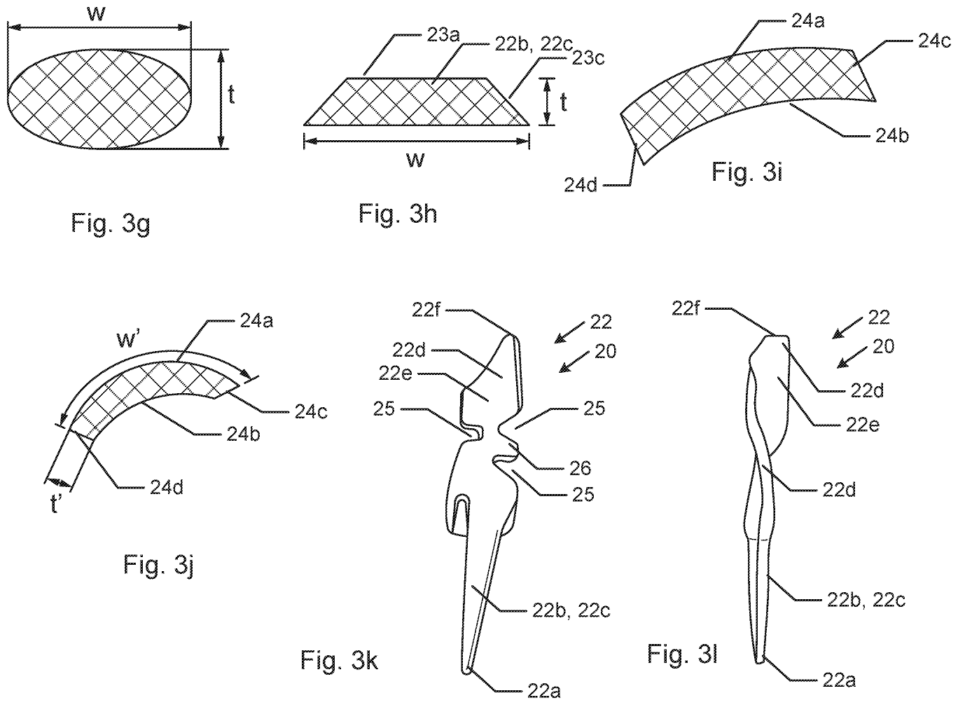

FIG. 3a is a front view of an implant in accordance with one or more embodiments of the present invention. FIG. 3b is a side view of the implant of FIG. 3a. FIGS. 3c-3h are cross-sectional views of an implant post of FIGS. 3a and 3b taken at line I-I. FIGS. 3i and 3i are cross-sectional views of an implant post of FIGS. 3a and 3b taken at line II-II. FIGS. 3k and 3l are isometric views of an implant in accordance with one or more embodiments of the present invention.

In accordance with one or more embodiments of the present invention, an implant 20 supports a prosthetic tooth in an anatomically correct shape of a maxillary or mandibular tooth. The implant includes a narrowed implant post 22 and a crown socket (not shown). Therein, the basic canal in many roots is very thin and made with very small endodontic tools that flex and are safe that can be accessed for the removal of an affected nerve. The ongoing professional discussion is whether to save such roots knowing that the root is connected for supporting a crown that may not be adequate to serve long-term survival of the root-crown process.

Implant 20 may be used in any circumstance but is preferably used, when in a non-idealized jaw, the longitudinal axis Y-Y of implant post 22 coincides with the axis of the osteotomy but may not coincide with the longitudinal axis of the crown.

Implant post 22 preferably comprises a distal end 22a for being received first in a patient's jaw as is known in the art and a support end 22d used to support a crown. Distal end 22a may have any suitable shape, but preferably has a tip shape, a rounded shape, or a flat shape.

Implant post 22 is preferably made of any suitable material for an implant post including titanium, tungsten, zirconium oxide, hafnium, yttrium, an alloy thereof, and/or a combination thereof Where implant post 22 is intended for use as an analog, implant post 22 may be made of plastic, fiberglass, or other material less expensive than titanium, tungsten, zirconium oxide, hafnium, yttrium, an alloy thereof, and/or a combination thereof

A shank 22b includes a blade portion 22c; blade portion 22c has a width w and a thickness t in a cross-section substantially transverse to a longitudinal axis Y-Y of an implant post 22 in a first state where the implant post is unbent. Longitudinal axis Y-Y coincides with the longitudinal axis of the osteotomy and in an idealized jaw coincide a longitudinal axis of the crown. In a non-idealized jaw, longitudinal axis Y-Y preferably coincides with the axis of the osteotomy but may not coincide with the longitudinal axis of the crown because implant post 22 has been placed in a second state comprising a “bend” in the longitudinal axis Y-Y to be directionally adjustable to a longitudinal axis Y′-Y′ to permit an aesthetic functioning crown to be placed to meet the patient's functional and aesthetic needs in a non-idealized jaw.

Preferably, implant post 22 may be made of a solid titanium alloy. Preferably, implant post 22 is 3-4 mm in length along longitudinal axis Y-Y.

Width w is the maximal dimension of a first side surface 23a or a second side surface 23b and thickness t is the maximal dimension of a first end surface 23c or a second end surface 23d.

Therein, blade portion 22c has a shape form factor F defined as a ratio of w to t, i.e., w:t or also w/t of 3.0 to 20.0. For example, a form factor F of 5.5 would mean that first side surface 23a could be 5.5 times longer than a first end surface 23c. In accordance with one embodiment of the present invention, F is preferably between 6.0 to 12.0 for stability.

In accordance with one or more embodiments of the present invention, blade portion 22c is formed to be substantially rectangular in cross-section. That is, blade portion 22c has a first pair of surfaces, namely first side surface 23a and second side surface 23b, that are substantially parallel to each other when viewed in cross-section and a second pair of surfaces, namely first end surface 23c and second end surface 23d, that are substantially parallel to each other when viewed in cross-section. Side surfaces 23a, 23b are preferably substantially perpendicular to end surfaces 23c, 23d in cross-section.

In accordance with one or more embodiments of the present invention, blade portion 22c may have any suitable shape including having rectangular, irregular, or tapered first side surface 23a and/or second side surface 23b and/or first end surface 23c and/or a second end surface 23d.

In accordance with one or more embodiments of the present invention, blade portion 22c has a first pair of surfaces, namely first side surface 23a and second side surface 23b, that are each arcuate when viewed in cross-section and a second pair of surfaces, namely first end surface 23c and second end surface 23d, that are substantially planar to each other when viewed in cross-section.

In accordance with one or more embodiments of the present invention, blade portion 22c has a first pair of surfaces, namely first side surface 23a and second side surface 23b, that are each arcuate when viewed in cross-section and a second pair of surfaces, namely first end surface 23c and second end surface 23d, that are substantially planar to each other when viewed in cross-section.

In accordance with one or more embodiments of the present invention, blade portion 22c has a first pair of surfaces, namely first side surface 23a and second side surface 23b, that are each arcuate when viewed in cross-section and a second pair of surfaces, namely first end surface 23c and second end surface 23d, that each arcuate when viewed in cross-section.

In accordance with one or more embodiments of the present invention, blade portion 22c has a first pair of surfaces, namely first side surface 23a and second side surface 23b, that have an irregular shape and a second pair of surfaces, namely first end surface 23c and second end surface 23d, that have any suitable shape or that have an irregular shape.

In accordance with one or more embodiments of the present invention, first side surface 23a may have a different shape than second side surface 23b and/or first end surface 23c may have a different shape than second end surface 23d.

In accordance with one or more embodiments of the present invention, where necessary, the corners where side surfaces 23a, 23b meet end surfaces 23c, 23d are preferably rounded for safety, ease of use, ease of manufacture, patient comfort, and/or any other suitable reason.

Therein, implant post 22 may be used to support an implant in a root that has been cleaned out and/or a root that is not circular by virtue of having a blade portion 22c that may have any suitable shape including having rectangular, irregular, or tapered first side surface 23a and/or second side surface 23b and/or first end surface 23c and/or a second end surface 23d. This also permits implant post 22 to be cemented in the cleaned out in available root space and/or within the remaining outer walls of the conserved tooth portion even when such a tooth portion or walls have cracks.. The implant post is connected to remaining tooth structure to provide an extra well-supported structure in excess of what is normally possible with an implant post having a regular round or ovoid shape.

In accordance with one or more embodiments of the present invention, regardless of their respective shapes, each or both side surfaces and/or each or both end surfaces may comprise texture. The texture may be pitting in a regular geometric patter, pitting in a random fashion, one or more ridges, one or more indentations, one or more regular or irregular shapes, and/or any other feature that may aid in securing implant post 22 and/or osseointegrate implant post 22.

Implant post 22 further comprises a support end 22d. In accordance with one or more embodiments of the present invention, support end 22d may be in the form of an abutment as taught by the references disclosed further herein.

In accordance with one or more embodiments of the present invention, instead of an abutment, support end 22d comprises a twist portion 22e that is directly or indirectly connected to, unitary with, or adjacent to shank 22b that places support end 22d in a second plane that is different than the first plane.

In accordance with one or more embodiments of the present invention, twist portion 22e has a width w′ and a thickness t′ in a cross-section substantially transverse to a longitudinal axis Y-Y.

Width w′ is the maximal arcuate dimension of a first side surface 24a or a second side surface 24b and thickness t′ is the maximal arcuate dimension of a first end surface 24c or a second end surface 24d. Therein, twist portion has a shape form factor F′ defined as a ratio of w′ to t′, i.e., w′:t′ or also w′/t′ of 3.0 to 20.0. For example, a form factor F′ of 5.5 would mean that first side surface 24a could be 5.5 times longer than a first end surface 24c.

Twist portion 22e is preferably formed unitarily with shank 22b for stability, strength, ease of use, ease of manufacturing, patient comfort, and/or any other suitable portion.

Twist portion 22e may comprise one or more twists, i.e., 360 degree turns, but preferably comprises less than a full turn. Herein, the turn is measured starting from a juncture 22g of shank 22b and support end 22d and ending at end surface 22f disposed at an outer surface of support end 22d and wherein end surface 22f is substantially perpendicular to first side surface 24a, second side surface 24b, first end surface 24c, and/or second end surface 24d.

In accordance with one or more embodiments of the present invention, twist portion 22e comprises a ¼ turn, i.e., a 90 degree turn. Therein, the turn need not begin at the juncture of shank 22b and support end 22d, but rather may begin at any suitable location in support end 22d.

Twist portion 22e may comprises one or more indentations 25 that preferably aid in securing a crown (not shown) to implant post 22. Indentations 25 may be arranged such that tangs 26 are so disposed to engage with a crown.

In accordance with one or more embodiments of the present invention, implant post 22 comprises shank 22b that has a width w that is smaller than a width w′ of support end 22d. That is, shank 22b is significantly smaller in width and/or thickness than support end 22d. Thus, juncture 22g may define an abrupt transition in width and/or thickness.

FIG. 3m is a schematic of implant of FIGS. 3a and 3b illustrating a bend in the implant. The “bend” preferably is located at juncture 22g in implant 20 the bend B is between idealized jaw axis Y-Y for the roots and non-idealized jaw axis Y′-Y′ for the crown result in a difference measurable in degrees of B′.

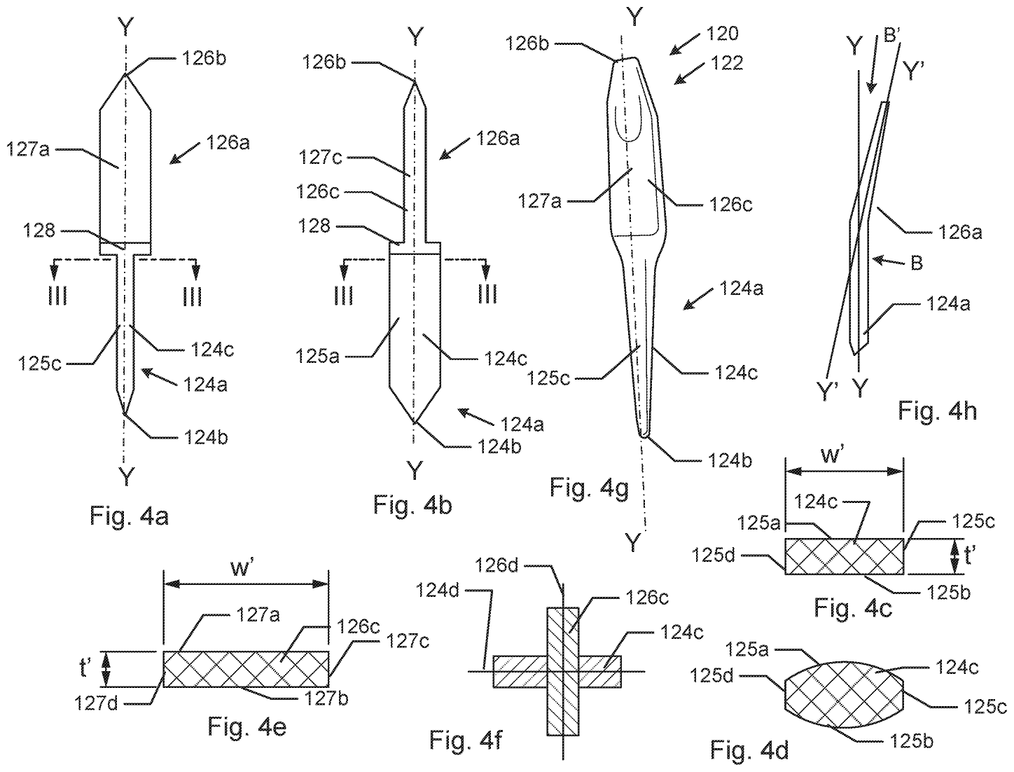

FIG. 4a is a front view of an implant in accordance with one or more embodiments of the present invention. FIG. 4b is a side view of the implant of FIG. 4a. FIGS. 4c-4e are cross-sectional views of an implant post of FIGS. 4a and 4b taken at line FIG. 4f is a schematic views of the planes of implant of FIGS. 4a and 4b. FIG. 4g is an isometric view of an implant in accordance with one or more embodiments of the present invention. FIG. 4h is a schematic of implant of FIGS. 4a and 4b illustrating a bend in the implant.

In accordance with one or more embodiments of the present invention, an implant 120 supports a prosthetic tooth in an anatomically correct shape of a maxillary or mandibular tooth. The implant includes a narrowed implant post 122 (also known as a post) and a crown socket (not shown).

Implant post 122 preferably comprises a first shank 124a and a second shank 126a connected by a transition portion 128. Therein, first shank 124a may be placed into an osteotomy and second shank 126a is a support for crown (not shown).

Implant 120 may be used in any circumstance but is preferably used, when in a non-idealized jaw, the longitudinal axis Y-Y of implant post 122 having a first shank disposed in a first longitudinal plane comprising the axis of the osteotomy and a second shank disposed in a second longitudinal plane that comprises the longitudinal axis of the crown, wherein the first and second planes are not coincident.

Implant post 122 is preferably made of any suitable material for an implant post including titanium, tungsten, zirconium oxide, hafnium, yttrium, an alloy thereof, and/or a combination thereof. Where implant post 122 is intended for use as an analog, implant post 122 may be made of plastic, fiberglass, or other material less expensive than titanium, tungsten, zirconium oxide, hafnium, yttrium, an alloy thereof, and/or a combination thereof.

First shank 124a is received in a patient's jaw as is known in the art. First shank 124a has a distal end 124b that may have any suitable shape, but preferably has a tip shape, a rounded shape, or a flat shape.

First shank 124a includes a blade portion 124c having a width w and a thickness tin a cross-section substantially transverse to a longitudinal axis Y-Y of an implant post 122 in a first state where the implant post is unbent. Longitudinal axis Y-Y coincides with the longitudinal axis of the osteotomy and in an idealized jaw coincide a longitudinal axis of the crown. In a non-idealized jaw, longitudinal axis Y-Y preferably coincides with the axis of the osteotomy but may not coincide with the longitudinal axis of the crown because implant post 122 has been placed in a second state comprising a “bend” in the longitudinal axis Y-Y to be directionally adjustable and to permit an aesthetic functioning crown to be placed to meet the patient's functional and aesthetic needs in a non-idealized jaw.

Preferably, implant post 122 may be made of a solid titanium alloy. Preferably, implant post 122 is 3-4 mm in length along longitudinal axis Y-Y.

Width w is the maximal dimension of a first side surface 125a or a second side surface 125b and thickness t is the maximal dimension of a first end surface 125c or a second end surface 125d, which may substantially correspond to side surfaces 24a, 24b and end surfaces 24c, 24d, respectively of implant 20. Therein, blade portion 124c has a shape form factor F defined as a ratio of w to t, i.e., w:t or also w/t of 3.0 to 20.0. For example, a form factor F of 5.5 would mean that first side surface 125a could be 5.5 times longer than a first end surface 125c. In accordance with one embodiment of the present invention, F is preferably between 6.0 to 12.0 for stability.

Second shank 126a includes a blade portion 126c having a width w and a thickness t in a cross-section substantially transverse to a longitudinal axis Y-Y of an unbent implant post 122. Longitudinal axis Y-Y typically would coincide with the axis of the osteotomy.

Preferably, implant post 122 may be made of a solid titanium alloy. Preferably, implant post 122 is 3-4 mm in length along longitudinal axis Y-Y.

Width w is the maximal dimension of a first side surface 127a or a second side surface 127b and thickness t is the maximal dimension of a first end surface 127c or a second end surface 127d, which may substantially correspond to side surfaces 24a, 24b and end surfaces 24c, 24d, respectively of implant 20. Therein, blade portion 126c has a shape form factor F defined as a ratio of w to t, i.e., w:t or also w/t of 3.0 to 20.0. For example, a form factor F of 5.5 would mean that first side surface 127a could be 5.5 times longer than a first end surface 127c. In accordance with one embodiment of the present invention, F is preferably between 6.0 to 12.0 for stability.

FIG. 4f is a schematic views of the planes of implant of FIGS. 4a and 4b. First shank 124a defines a first longitudinal plane 124d that, in an unbent state, is substantially parallel to first side surface 125a or second side surface 125b or both first side surface 125a and second side surface 125b. Second shank 126a define a second longitudinal plane 126d that, in an unbent state, is substantially parallel to first side surface 127a or second side surface 127b or both first side surface 127a and second side surface 127b.

First longitudinal plane 124d and second longitudinal plane 126d are, preferably, disposed such that in an unbent state, at least one line lies in both planes. That is, first longitudinal plane 124d and second longitudinal plane 126d are preferably not coincident but intersect each other. Most, first longitudinal plane 124d and second longitudinal plane 126d are rotated relative to each other by 90 degrees.

Transition portion 128 may be any suitable shape that joins first shank 124a and second shank 126a. However, preferably, transition portion 128 comprises a platform that is in a cross-section relative to first longitudinal plane 124d or second longitudinal plane 126d encompasses, is, or substantially is a regular geometric figure such as a circle, an octagon, a hexagon, a septagon, or a rectangle. Transition portion 128 may be any suitable thickness, but preferably comprises a thickness identical or substantially similar to first side surface 125a, second side surface 125b, first side surface 127a, or second side surface 127b.

In accordance with one or more embodiments of the present invention, first shank 124a and second shank 126a are substantially identical in dimension, size, and shape but rotated relative to each other by one or more predetermined degrees such as 90 degrees to maximize use of each shank's bending inertia.

FIG. 4h is a schematic of implant of FIGS. 4a and 4b illustrating a bend in the implant. Each implant post 22 or 122, preferably, comprises a first state wherein it is unbent, i.e., unbent state, and a second state where it is bent, if necessary, to accompany an osteotomy. That is, each implant post 22 or 122 can be bent along axis Y-Y so that the implant post so that the post can be used for the replacement of a non-idealized tooth.

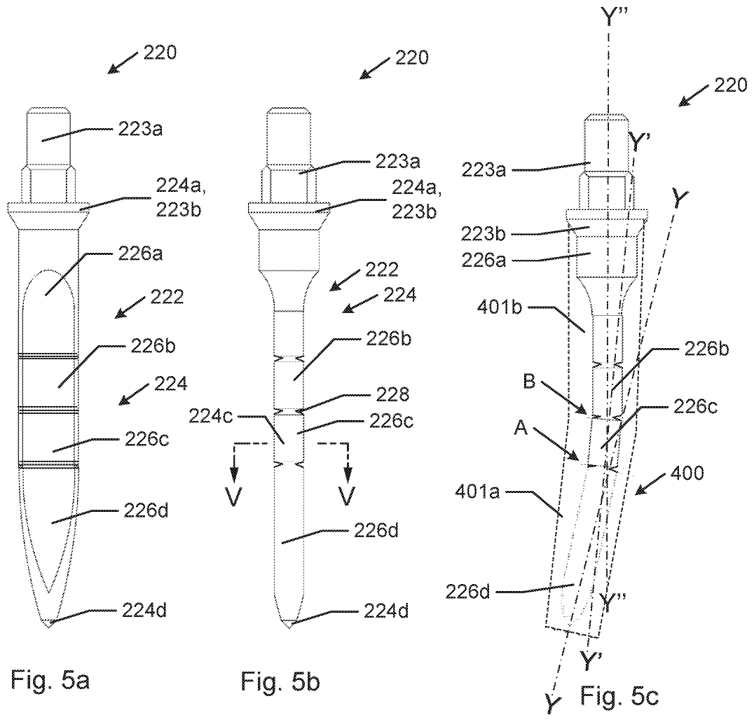

FIG. 5a is a front view of an implant in accordance with one or more embodiments of the present invention. FIG. 5b is a side view of the implant of FIG. 5a. FIG. 5c is a schematic of implant of FIGS. 5a and 5b illustrating one or more bends in the implant.

In accordance with one or more embodiments of the present invention, an implant 220 supports a prosthetic tooth in an anatomically correct shape of a maxillary or mandibular tooth. The implant includes a narrowed implant post 222 (also known as a post), a crown socket 223a, shown in a simplified version, and an abutment 223b. Implant post 220 may be used in any circumstance but is preferably used when an osteotomy has at least a first osteotomy section that is angled relative to a second osteotomy section.

Implant post 222 preferably comprises a shank 224 having a plurality of indentations 228 that define a plurality of shank sections, for example, sections 226a, 226b, 226c, and 226d. Therein, shank 224 is received in a patient's jaw as is known in the art. Shank 224 has proximal end 224a that is preferably is considered to be part of abutment 223b and a distal end 224b that may have any suitable shape, but preferably has a tip shape, a rounded shape, or a flat shape.

Shank 224 includes a blade portion 224c having a width w and a thickness tin a cross-section V-V that us substantially transverse to a longitudinal axis Y-Y of an implant post 222 in a first state where the implant post is unbent, i.e. geometrically displaced.

Longitudinal axis Y-Y coincides with the longitudinal axis of the osteotomy and in an idealized jaw coincide a longitudinal axis of the crown. In a non-idealized jaw, longitudinal axis Y-Y preferably coincides with the axis of the osteotomy but may not coincide with the longitudinal axis of the crown because implant post 222 has been placed in a second state comprising a “bend” in the longitudinal axis Y-Y to be directionally adjustable to permit an aesthetic functioning crown to be placed to meet the patient's functional and aesthetic needs in a non-idealized jaw.

Implant post 222 is preferably made of any suitable material for an implant post including titanium, tungsten, zirconium oxide, hafnium, yttrium, an alloy thereof, and/or a combination thereof Where implant post 222 is intended for use as an analog, implant post 222 may be made of plastic, fiberglass, or other material less expensive than titanium, tungsten, zirconium oxide, hafnium, yttrium, an alloy thereof, and/or a combination thereof

Preferably, implant post 222 may be made of a solid titanium alloy. Preferably, implant post 222 is 3-4 mm in length along longitudinal axis Y-Y.

With respect to implant 220, width w is the maximal dimension of a first side surface or a second side surface and thickness t is the maximal dimension of a first end surface or a second end surface, which may substantially correspond to side surfaces 24a, 24b and end surfaces 24c, 24d, respectively of implant 20. Therein, blade portion 224c has a shape form factor F defined as a ratio of w to t, i.e., w:t or also w/t of 3.0 to 20.0. For example, a form factor F of 5.5 would mean that first side surface could be 5.5 times longer than a first end surface. In accordance with one embodiment of the present invention, F is preferably between 6.0 to 12.0 for stability.

In accordance with one or more embodiments of the present invention, a first section (for example 226a, 226b, 226c) and a second section (for example 226b, 226c, 226d respectively) are substantially identical in dimension, size, and shape but rotatable relative to each other by one or more predetermined degrees to be directionally adjustable. The degrees are determined based on the shape of the respective indentation 228.

Indentation 228 may have any suitable shape but preferably comprises a shape having a V-notch, a W-notch, a U-shaped notch, or a combination thereof. Therein, the predetermined degrees may be 1-20 degrees, or more preferably, 5-7.5 degrees. Preferably, indentations 228 extend across the entirety of respective end surfaces.

FIG. 5c is a schematic of implant of FIGS. 5a and 5b illustrating one or more bends in the implant. An osteotomy 401 has been prepared and includes an angled section 401a and a non-angled section 401b, i.e. section 401b is angled relative to section 401a, to permit an aesthetic functioning crown to be placed to meet the patient's functional and aesthetic needs in a non-idealized jaw.

By way of example, section 226d may be directionally adjusted relative section 226c in a bend A by compressing the respective indentation 228 so that section 226d has a longitudinal axis Y-Y. Section 226c may be directionally adjusted relative section 226b in a bend B by compressing the respective indentation 228 so that section 226c has a longitudinal section Y′-Y′. Sections 226b and 226a may also be directional adjustable, but in this example are located at longitudinal axis Y″-Y″ which also passes through crown socket 223a.

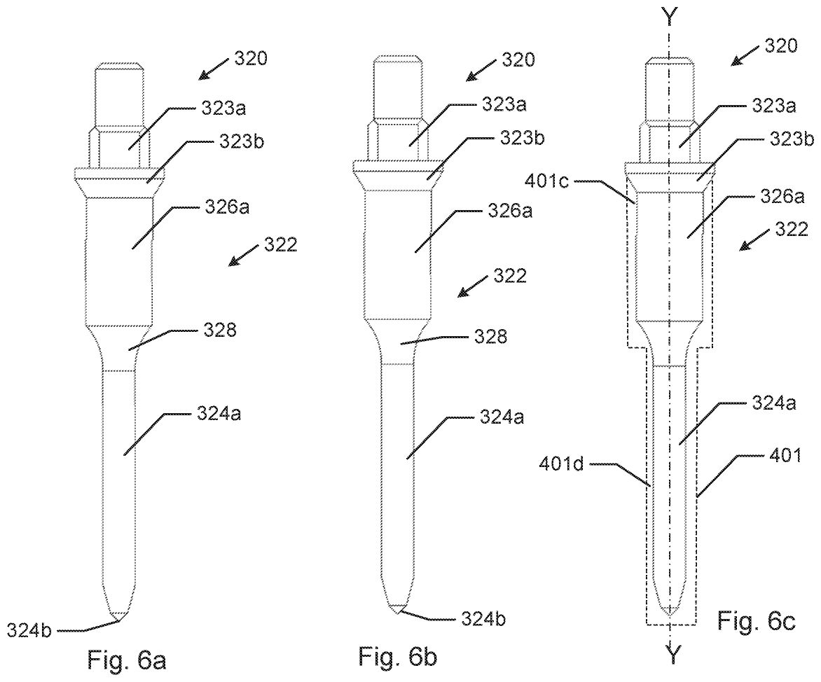

FIG. 6a is a side view of an implant in accordance with one or more embodiments of the present invention. FIG. 6b is a front view of the implant of FIG. 6a. FIG. 6c is a schematic of implant of FIGS. 6a and 6b illustrating one or more bends in the implant.

In accordance with one or more embodiments of the present invention, an implant 320 supports a prosthetic tooth in an anatomically correct shape of a maxillary or mandibular tooth. The implant includes an implant post 322, a crown socket 323a, and an abutment 323b. Implant 320 may be used in any circumstance but preferably is used in an osteotomy having a first osteotomy section and a second osteotomy section having a greater cross-sectional area than a cross-sectional area of the first osteotomy section.

Implant post 322 preferably comprises a first shank 324a disposed in the first osteotomy section and a second shank 326a in the second osteotomy section and wherein the first and second shanks are connected by a transition portion 328.

Implant post 322 is preferably made of any suitable material for an implant post including titanium, tungsten, zirconium oxide, hafnium, yttrium, an alloy thereof, and/or a combination thereof Where implant post 322 is intended for use as an analog, implant post 322 may be made of plastic, fiberglass, or other material less expensive than titanium, tungsten, zirconium oxide, hafnium, yttrium, an alloy thereof, and/or a combination thereof.

The first and second shanks are received in a patient's jaw as is known in the art. First shank 324a has a distal end 324b that may have any suitable shape, but preferably has a tip shape, a rounded shape, or a flat shape.

First shank 324a includes a blade portion 324c having a width w and a thickness t in a cross-section substantially transverse to a longitudinal axis Y-Y of an implant post 322. Longitudinal axis Y-Y coincides with the longitudinal axis of the osteotomy and in an idealized jaw coincide a longitudinal axis of the crown. In a non-idealized jaw, longitudinal axis Y-Y preferably coincides with the axis of the osteotomy but may not coincide with the longitudinal axis of the crown because implant post 322 has been placed in a second state comprising a “bend” in the longitudinal axis Y-Y to be directionally adjustable and to permit an aesthetic functioning crown to be placed to meet the patient's functional and aesthetic needs in a non-idealized jaw.

Preferably, implant post 322 may be made of a solid titanium alloy. Preferably, implant post 322 is 3-4 mm in length along longitudinal axis Y-Y.

With respect to first shank 324a, width w is the maximal dimension of a first side surface or a second side surface and thickness t is the maximal dimension of a first end surface or a second end surface, which may substantially correspond to side surfaces 24a, 24b and end surfaces 24c, 24d, respectively of implant 20. Therein, blade portion 124c has a shape form factor F defined as a ratio of w to t, i.e., w:t or also w/t of 3.0 to 20.0. For example, a form factor F of 5.5 would mean that first side surface could be 5.5 times longer than a first end surface. In accordance with one embodiment of the present invention, F is preferably between 6.0 to 12.0 for stability.

Second shank 326a includes a blade portion having a width w and a thickness t in a cross-section substantially transverse to a longitudinal axis Y-Y of an unbent implant post 122. Longitudinal axis Y-Y typically would coincide with the axis of the osteotomy. Preferably, implant post 122 may be made of a solid titanium alloy. Preferably, implant post 122 is 3-4 mm in length along longitudinal axis Y-Y.

With respect to second shank 326a, width w is the maximal dimension of a first side surface or a second side surface and thickness t is the maximal dimension of a first end surface or a second end surface, which may substantially correspond to side surfaces 24a, 24b and end surfaces 24c, 24d, respectively of implant 20. Therein, blade portion 126c has a shape form factor F defined as a ratio of w to t, i.e., w:t or also w/t of 3.0 to 20.0. For example, a form factor F of 5.5 would mean that first side surface could be 5.5 times longer than a first end surface. In accordance with one embodiment of the present invention, F is preferably between 6.0 to 12.0 for stability.

In accordance with one or more embodiments of the present invention, first shank 324a or second shank 326a comprise a circular cross-section substantially transverse to a longitudinal axis Y-Y of an implant post 322. In accordance with one or more embodiments of the present invention, first shank 324a or second shank 326a comprise a circular cross-section substantially transverse to a longitudinal axis Y-Y of an implant post 322.

Transition portion 328 may be any suitable shape that joins first shank 124a and second shank 326a. A surface texturing 330 may be provided on shank 324a and/or 326a to more quickly osseointegrate the respective shank.

Preferably, first shank 324a and second shank 326a are disposed in a single linear axis Y-Y. Therein, first shank 324a has a very narrow size in order to fit in an implant space 4a while second shank 326a has a large size to fit in an implant space that is large near the surface of the bone. In accordance with one or more embodiments of the present invention, shank 324a has a diameter of 0.5 mm-2.5 mm in cross-section or is 0.5 mm-2.5 mm on each side of shank 324a in cross-section. In accordance with one or more embodiments of the present invention, shank 326a has a diameter of 1 mm-2 mm in cross-section or is 2 mm-5 mm on each side of shank 326a in cross-section. In accordance with one or more embodiments of the present invention, shank 324a has a diameter of 1 mm-2.5 mm in cross-section or is 1 mm-2.5 mm on each side of shank 324a in cross-section and shank 326a has a diameter of 2 mm-5 mm in cross-section or is 2 mm-5 mm on each side of shank 326a in cross-section.

In accordance with one or more embodiments of the present invention, implant 320 is made of a single piece of material that is machined to shape each portion of implant 320. In accordance with one or more embodiments of the present invention, implant 320 is printed using an additive printer.

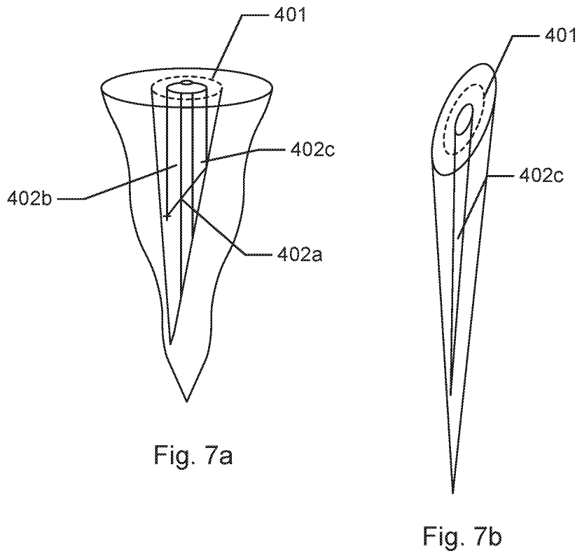

FIGS. 7a and 7b are schematic views of an osteotomy in accordance with one or more embodiments of the present invention.

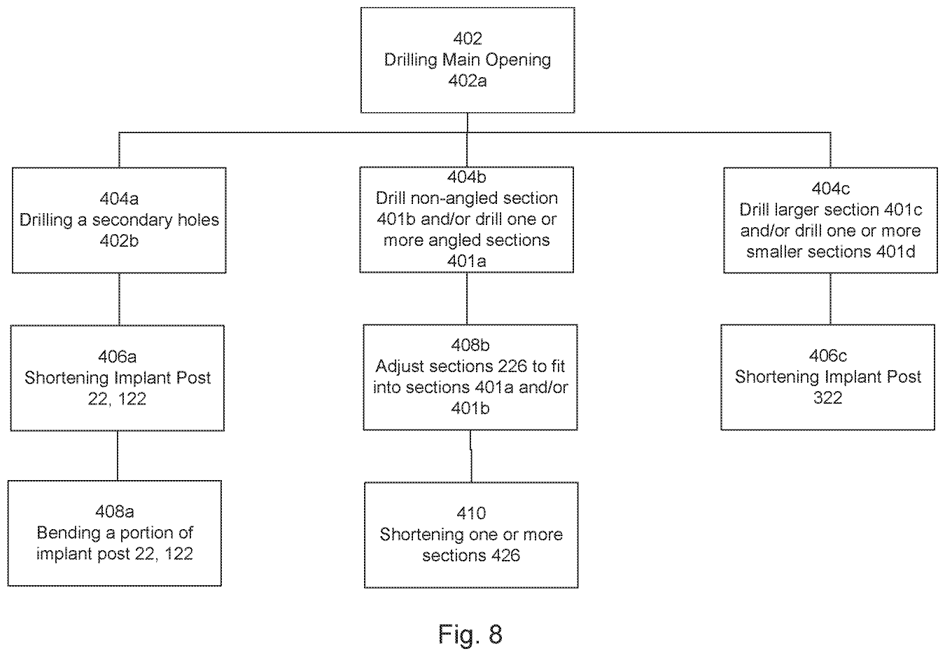

FIG. 8 is a schematic of an osteotomy in accordance with one or more embodiments of the present invention. In accordance with one or more embodiments of the present invention, using a method 400, an osteotomy 401 is performed by a qualified medical and/or dental professional using implant 20, implant 120, or implant 220 to install the respective implant in a patient.

In a step 402, an main opening 402a is visually drilled to a desired depth. That is, the professional may determine any suitable depth.

In a step 404a, a jig, as for example, one taught in U.S. Pat. No. 9,345,559B, is used to visually drill one or more secondary holes 402b to create a slot 401c, i.e., canal. For example, each of main opening 402a, the one or more secondary 402b, and slot 402c may be drilled to a depth 5 mm.

In a step 406a, the professional will shorten implant post 22 is shortened by removing a portion of distal end 22a or implant post 122 is shortened by removing a portion of distal end 124b to suitably fit in slot 401d. Where necessary or so desired, an analog of implant 20, implant 120, implant 220, implant 320 may be used to determine the suitable depth by removing one or more times a portion of distal end 22a or distal end 124b.

In order to permit an aesthetic functioning crown to be placed to meet the patient's functional and aesthetic needs, implant 20 or implant 120 can be bent in a step 408a, i.e., placed into second state where a “bend” is placed in. That is, in a non-idealized jaw, longitudinal axis Y-Y preferably coincides with the axis of the osteotomy but may not coincide with the longitudinal axis of the crown because implant post 122 has been placed in a second state comprising a “bend” in the longitudinal axis Y-Y to permit an aesthetic functioning crown to be placed to meet the patient's functional and aesthetic needs in a non-idealized jaw.

The “bend” preferably is located at juncture 22g in implant 20 or in or proximal in transition 128 as for example, shown in FIG. 4h wherein the bend B is between idealized jaw axis Y-Y for the roots and non-idealized jaw axis Y′-Y′ for the crown result in a difference measurable in degrees of B′.

Accordingly, anterior teeth, i.e., the roots, which are ovoidal with very limited space for repair can be drilled and implant 20 or implant 120 can be placed. A coronal form can then be created for aesthetic functioning crowns to meet the patient's aesthetic and functional needs. Therein, the proposed concept of flat form implant provides space in canal to perform the very delicate location of the canal and to have aesthetic functioning crowns.

For implant 220, method 400 may be changed as follows: in a step 404b, the non-angled section 401b and/or one or more angled sections 401a are drilled. In a step 408b, sections 226 fit into sections 401a and/or 401b are adjusted and in a step 410, one or more sections 426 are shortened, if necessary.

For implant 320, method 400 may be changed as follows: in a step 404c, the larger and smaller sections 401c and 401d are drilled. In a step 406c, implant post 322 are shortened, if necessary.

Abutment and/or crown socket may be one as known in U.S. Ser. No. 12/613,017, published as U.S. Patent Application Publication 2011/0104637. U.S. Ser. No. 12/613,017, published as U.S. Patent Application Publication 2011/0104637, is hereby incorporated by reference in its entirety for all purposes. An abutment may also be any suitable type of abutment that is known in the art, but is preferably one made according to the teachings of U.S. Pat. Nos. 5,785,525 and/or 6,685,473, which are herein incorporated in their entirety for all purposes. All exterior surfaces

While the invention has been described in conjunction with specific embodiments, it is to be understood that many alternatives, modifications, and variations will be apparent to those skilled in the art in light of the foregoing description.

What is claimed is:

1. A dental implant comprising:
a crown socket for supporting a prosthetic tooth in an anatomically correct shape;
an abutment; and
an implant post having a first longitudinal axis coinciding with a second longitudinal axis of an osteotomy;
wherein the implant post does not comprise a circular cross-section in the second longitudinal axis.

2. The dental implant of claim 1, wherein the implant post comprises a rectangular cross-section perpendicular to the, the rectangular cross-section having a first side longer than a second side.

3. The dental implant of claim 2, wherein the implant post comprises a first shank portion and a second shank portion, the second shank portion being rotated relative to the first shank portion.

4. The dental implant of claim 3, wherein the first shank portion is joined to the second portion by a twist portion.

5. A dental implant comprising:
a crown socket for supporting a prosthetic tooth, the crown socket comprising a first longitudinal axis for supporting the prosthetic tooth in an anatomically correct shape;
an abutment; and
an implant post having a second longitudinal axis coinciding with a third longitudinal axis of an osteotomy;
wherein the first longitudinal axis and the second longitudinal axis are not coincident.

7. The dental implant of claim 6, wherein the crown socket is bent at a juncture relative to the implant post.

8. The dental implant of claim 7, wherein the implant post comprises a plurality of sections.

9. The dental implant of claim 8, wherein each section is joined by a transition section to another sections.

10. The dental implant of claim 9, wherein the transition section comprises a V-notch.
